(19) United States
(12) Patent Application Publication
(10) Pub. No.: US 2026/0067602 A1
(43) Pub. Date: Mar. 5, 2026

(54) STAKES FOR OUTDOOR SPEAKERS AND RELATED SYSTEMS AND METHODS

(71) Applicant: SoundStake, LLC, Glendale, AZ (US)

(72) Inventors: Ryan D. Maguire, Glendale, AZ (US); James F. Reed, Mesa, AZ (US); Daniel G. Reed, Mesa, AZ (US)

(21) Appl. No.: 19/312,591

(22) Filed: Aug. 28, 2025

Related U.S. Application Data
(60) Provisional application No. 63/687,920, filed on Aug. 28, 2024.

(51) Int. Cl. H04R 1/02

(52) U.S. Cl. CPC H04R 1/026; H04R 2201/025

(57) ABSTRACT

A stake for an outdoor fixture includes a body including a proximal end portion and an opposite distal end portion, the body defining a longitudinal axis. The body includes: a head at the proximal end portion of the body; a tip at the distal end portion of the body; a shaft extending along the longitudinal axis between the head and the tip; an auger on the shaft; and a ground cap between the auger and the head. The head is shaped and configured to be coupled to a power tool to drive the auger in the ground until the ground cap is at or adjacent the ground such that the stake is in an installed position.

### REFERENCE TO PRIORITY APPLICATION

The present application claims priority from U.S. Provisional Patent Application No. 63/687,920, filed Aug. 28, 2024, the disclosure of which is hereby incorporated by reference in its entirety.

### BACKGROUND

As shown in FIG. 1, known landscape speakers mount to a plastic stake. The stake is driven into the ground by a hammer or mallet. The stakes frequently bend or break during installation. Hard soil requires softening the ground with water—this leads to muddy, messy, slow, hard work—frustrating installers. Further, due to the traditional stake's design, the speaker frequently sags, leans, or falls soon after installation, negatively impacting the performance of the speaker, and tarnishing the installer's reputation and necessitating one or more return trips by the installer. Hard soil can also lead to difficult and time-consuming labor.

There is a need for a stake that can be more easily and effectively driven into the ground and stays in position such that the speaker or other connected component remains in its desired orientation.

### SUMMARY

Some embodiments of the present invention are directed to a stake for an outdoor fixture including a body including a proximal end portion and an opposite distal end portion, the body defining a longitudinal axis, the body including: a head at the proximal end portion of the body; a tip at the distal end portion of the body; a shaft extending along the longitudinal axis between the head and the tip; an auger on the shaft; and a ground cap between the auger and the head. The head is shaped and configured to be coupled to a power tool to drive the auger in the ground until the ground cap is at or adjacent the ground such that the stake is in an installed position.

In some embodiments, the head includes a sidewall defining a channel, and an inner surface of the sidewall optionally includes threads to threadingly engage an appliance when the stake is in the installed position. The sidewall may include at least one aperture configured to receive therethrough at least one conductor of the appliance.

In some embodiments, the auger includes a plurality of flights that are axially spaced apart from one another. The plurality of flights may decrease in diameter or width in a direction from the proximal end portion of the body to the distal end portion of the body. The auger may terminate before the ground cap such that a gap is defined between the ground cap and the flight closest to the ground cap.

In some embodiments, the shaft decreases in diameter in a direction from the ground cap to the tip.

In some embodiments, the body has a length between a proximal, terminal end of the body and a distal, terminal end of the body of between 8 and 12 inches.

In some embodiments, the ground cap has a diameter or width greater than a diameter or width of the auger.

In some embodiments, the body including the head, the tip, the shaft, the auger, and the ground cap is monolithic.

In some embodiments, the body includes aluminum. The body may include a hard anodized or powder coated finish.

Some other embodiments of the present invention are directed to a system for mounting an outdoor fixture, the system including an appliance, and a stake including a body including a proximal end portion and an opposite distal end portion, the body defining a longitudinal axis, the body including: a head at the proximal end portion of the body; a tip at the distal end portion of the body; a shaft extending along the longitudinal axis between the head and the tip; an auger on the shaft; and a ground cap between the auger and the head. The head is shaped and configured to be coupled to a power tool to drive the auger in the ground until the ground cap is at or adjacent the ground such that the stake is in an installed position. The head is configured to receive and hold the appliance in the installed position.

In some embodiments, the appliance includes a speaker.

Some other embodiments of the present invention are directed to a method for mounting an outdoor fixture. The method includes providing speaker assembly including: a speaker including a body and a base; and a stake including a body including a proximal end portion and an opposite distal end portion, the body defining a longitudinal axis, the body including: a head at the proximal end portion of the body; a tip at the distal end portion of the body; a shaft extending along the longitudinal axis between the head and the tip; an auger on the shaft; and a ground cap between the auger and the head. The method includes: driving the distal end portion and the auger of the stake into the ground until the ground cap is at or adjacent the ground; and connecting the speaker to the stake by connecting the base of the speaker to the head of the stake.

In some embodiments, the driving step is carried out by connecting a power tool to the head of the stake and operating the power tool to rotate the stake.

In some embodiments, the head includes a sidewall defining a channel configured to receive the base of the speaker, and at least one aperture is defined in the sidewall, the method further including routing at least one conductor of the speaker through the at least one aperture before the connecting step.

It is noted that any one or more aspects or features described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail in the specification set forth below.

Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1 schematically illustrates traditional stake installation instructions.

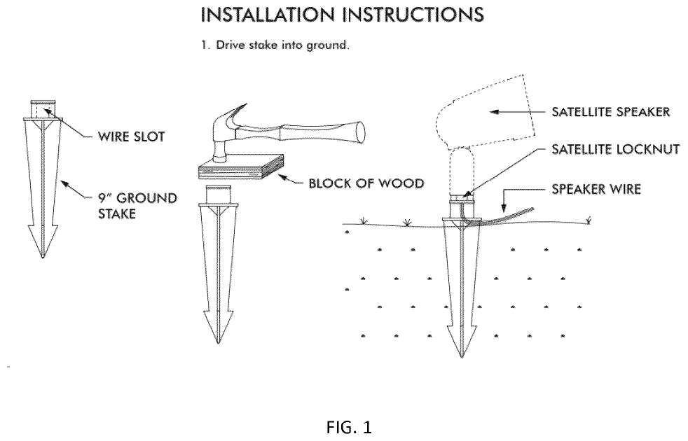

FIG. 2 is an exploded view of a speaker assembly according to some embodiments of the present invention.

FIG. 3 is a perspective view of a speaker of the assembly of FIG. 2.

FIG. 4 is a perspective view of a stake of the assembly of FIG. 2.

FIG. 5 is a side view of the stake of FIG. 4.

FIG. 6 is a top view of the stake of FIG. 4.

FIG. 7 is a sectional view of the stake of FIG. 4, taken along line A-A in FIG. 6.

FIG. 8 illustrates the stake of FIG. 4 installed in the ground and with a speaker connected thereto.

FIG. 9 is a perspective view of an extension rod according to some embodiments of the present invention.

FIG. 10 is a sectional view of the extension rod of FIG. 9.

FIG. 11 is a perspective view of a flag cap according to some embodiments of the present invention.

FIG. 12 is a perspective view of a static adapter according to some embodiments of the present invention.

FIG. 13 is a perspective view of a pivot adapter according to some embodiments of the present invention.

FIG. 14 is a perspective view of a swivel adapter according to some embodiments of the present invention.

### DETAILED DESCRIPTION

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Like numbers refer to like elements throughout. As used herein the term “and/or” includes any and all combinations of one or more of the associated listed items.

In addition, spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

Well-known functions or constructions may not be described in detail for brevity and/or clarity.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

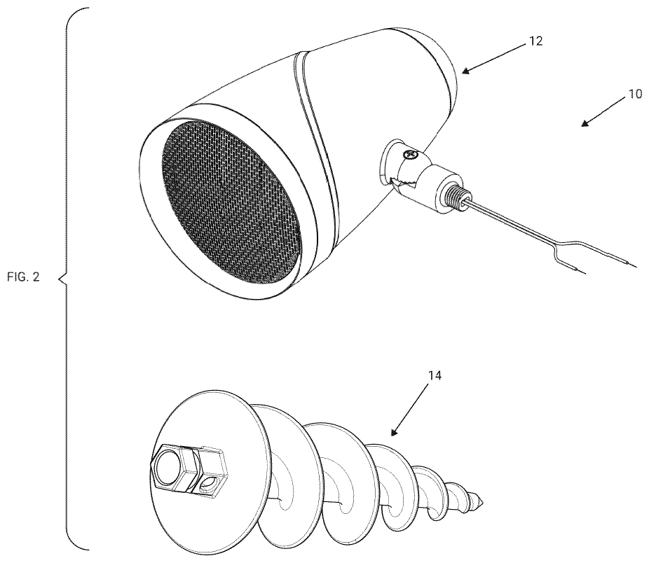

An appliance or speaker assembly or kit or system 10 according to some embodiments is illustrated in FIG. 2. The assembly 10 includes an appliance such as a speaker 12 and an anchor or stake 14.

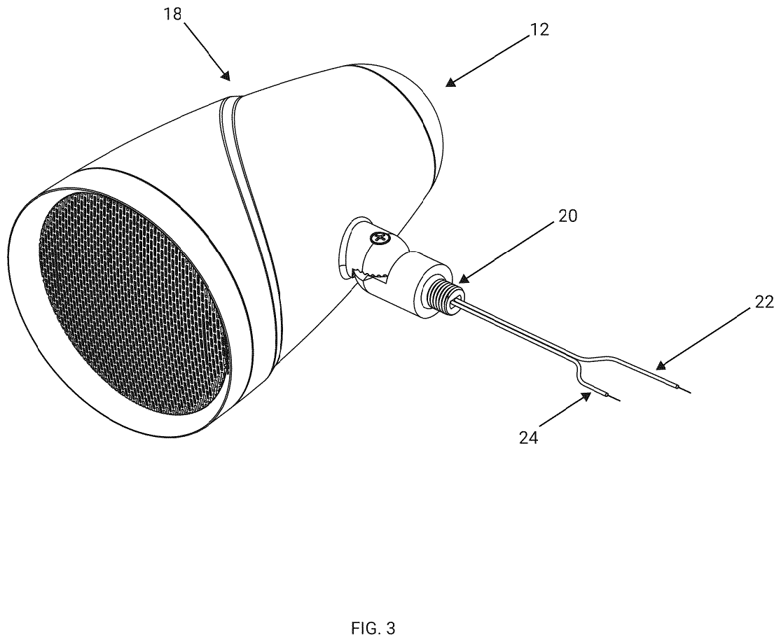

Referring to FIG. 3, the speaker 12 may include a body 18 and a base 20. The base 20 may be threaded for threading engagement with the stake 14, as described in more detail below. The speaker 12 may include first and second conductors 22, 24 that may extend from the body 18 and through the base 20.

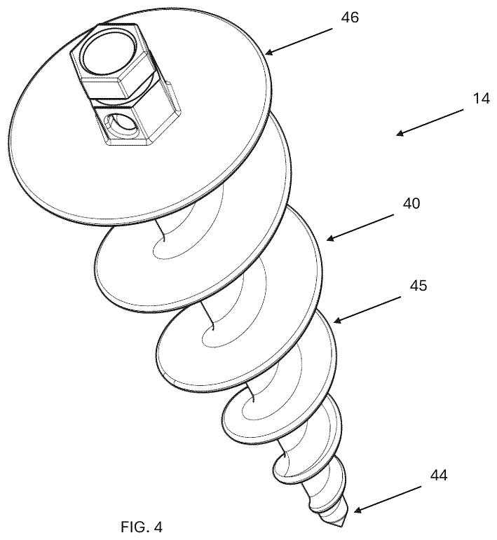

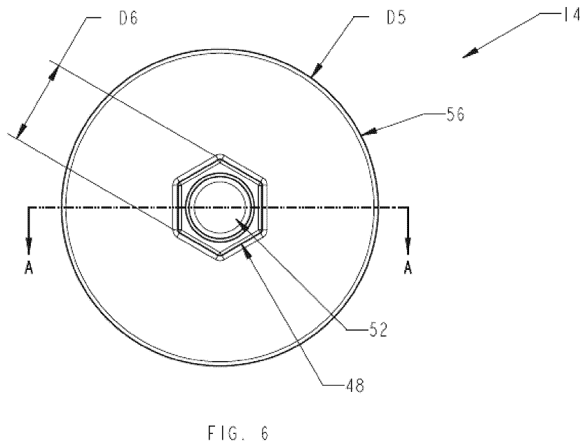

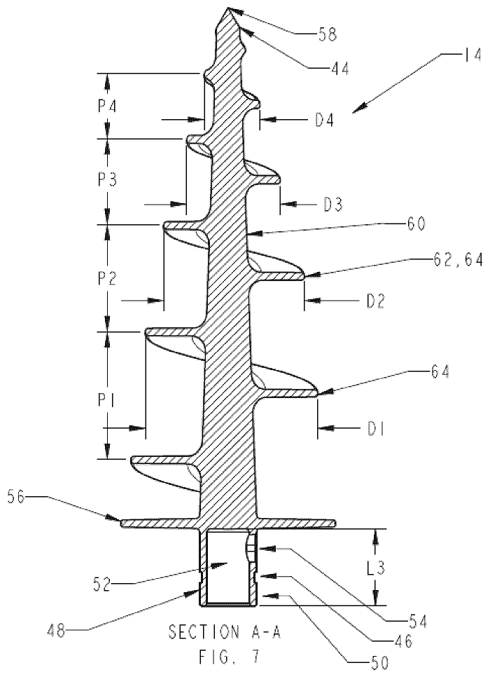

Referring to FIGS. 4-7, the stake 14 includes a body 40. The stake 14 defines a longitudinal axis A. The body 40 includes a distal (or first) end portion 44 and an opposite proximal (or second) end portion 46. The distal end portion 44 is configured to be driven into a surface such as the ground, as described in more detail herein. The body 40 includes an intermediate portion 45 between the distal and proximal end portions 44, 46.

The stake 14 includes a head 48 at the proximal end portion 46. The head 48 may have a polygonal profile or perimeter. For example, the head 48 may have a hexagonal shape. The head 48 may be configured to be received by a power tool such as an impact driver or drill to rotate the stake to thereby install the stake in the ground or other mounting surface.

The head 48 may include a wall or sidewall 50 that defines a channel 52. An inner surface of the channel 52 may be threaded and may be configured to receive and threadingly engage the base 20 of the speaker 12 (or other appliance). Other connection mechanisms for connecting the appliance to the stake are contemplated (e.g., fasteners, interference fit, etc.).

At least one hole or aperture 54 may be defined in the sidewall 50. In some embodiments, first and second apertures 54 are defined in the sidewall 50. The first and second apertures 54 may be diametrically opposed. The aperture(s) 54 may be configured to receive the conductors 22, 24 (FIG. 3) therethrough.

The stake 14 may include a ground cap 56 adjacent the head 48 (and adjacent the aperture(s) 54). The stake 14 may be driven into the ground or other mounting surface until the ground cap 56 is at or adjacent the ground or other mounting surface to provide a “stop” and/or to provide a clean finished appearance. This may be referred to as the installed position.

The aperture 54 may be positioned above the ground cap 56. This facilitates cable routing after the stake 14 has been installed in the ground in the installed position.

The ground cap 56 may help block water from flowing down the shaft to thereby minimize or reduce erosion around the blade and shaft.

The stake 14 or the body 40 thereof may include a tip 58 at the distal end portion 44. The tip 58 may be tapered and may terminate with a sharp point.

The stake 14 includes a shaft 60 extending along the longitudinal axis A between the head 48 and the tip 58. An auger or a helical blade 62 is on the shaft 60. The auger 62 includes a plurality of flights or blades 64 helically disposed on the shaft 60. The flights 64 may be axially spaced apart from one another.

In some embodiments, the auger 62 terminates a predetermined distance from the ground cap 56. There may be a gap G between the ground cap 56 and the blade 64 closest to the ground cap 56. The present inventors discovered that, when the auger 62 extended to the ground cap 56, pebbles became lodged between the blade and the ground cap. The gap G between the blade 64 and the ground cap 56 allows pebbles and other debris to pass without becoming lodged.

Further testing has confirmed an additional important benefit to the gap G between the auger blade 64 and the ground cap 56. The benefit is the compacting effect on the ground material (soil) as material moves into the narrowing channel between the ground cap and the blade. This is a significant source of grip strength for the invention. If there was no gap, the lack of escape path for the material would exert force to resist installation (a force in the opposite direction of the twisting motion of the stake during installation) versus allowing complete installation while compacting the material and securing the stake in the ground.

The blades or flights 64 may have a constant thickness. The thickness may be selected to be thin enough to cut through the soil and thick enough to remain intact during installation. The constant size (e.g., thickness) of the blade also requires less torque during installation versus a variable thickness blade (e.g., a blade that increases in thickness from the distal end portion to the proximal end portion).

In some embodiments, a width or diameter of the flights 64 (e.g., D1, D2, D3, D4) decreases in a direction extending from the proximal end portion 46 of the stake 14 to the distal end portion 44 of the stake 14. For example, the diameter D1 may be at least twice the diameter D4.

In some embodiments, a pitch or spacing between adjacent ones of the blades 64 (e.g., P1, P2, P3, P4) decreases in a direction extending from the proximal end portion 46 of the stake 14 to the distal end portion 44 of the stake 14. For example, the pitch P1 may be at least 1.5 or 1.75 times greater than the pitch P4.

The present inventors discovered that the variable pitch blade (and variable diameter blade) performed better than a constant pitch blade (and constant diameter blade). The ground cap may be thought of as a stopping plate; the blades below are pulling against the soil driving the stake down into the ground, but the ground cap acts as a stopper plate and results in compressed soil. The blade has variable pitch along with increasing diameter from the distal end portion to the proximal end portion. The blade travels the same path through the soil as the stake installs into the ground. The finer pitch and the smaller diameter of the blade at the distal end causes a slower, less aggressive start; at this stage of installation, the distal end functions like a drill bit disrupting more soil in order to dig the hole and clear a path for the stake. The rate of insertion into the ground accelerates as the stake travels into the ground because of the increasing pitch and diameter of the blade. Fewer rotations are required as the largest section of the blade enters the ground as the blade takes a larger bite while disrupting less soil during the final few turns or rotations.

Put another way, the distal portion of the blade has a reduced diameter and finer pitch, producing a controlled, low-torque start that guides the stake into the ground and forms a pilot path. As the blade transitions to greater pitch and diameter toward the proximal end, the axial advance per revolution increases, reducing the number of rotations needed to achieve full insertion. Although each revolution of the proximal portion displaces a larger soil volume, the coarser pitch limits the total number of rotations, thereby moderating cumulative soil disruption.

In some embodiments, the auger shaft 60 decreases in diameter in a direction extending from the proximal end portion 46 of the stake 14 to the distal end portion 44 of the stake 14. For example, the diameter of the shaft 60 at or adjacent the ground cap 56 may be greater than the diameter of the shaft 60 at or adjacent the tip 58. In some embodiments, the auger shaft 62 includes the tip 58.

The present inventors discovered that, compared with a constant diameter shaft, a shaft of increasing diameter from distal to proximal end performed better to compact the soil around the shaft and create an opposing force between the shaft and blade.

In some embodiments, the ground cap 56 has a diameter or width D5 that is greater than a diameter or width of the auger 62 (or any of the flights 64 thereof). In various embodiments, the diameter D5 may be between 2 and 6 inches, between 3 and 5 inches, between 3.25 and 4.25 inches, or about 3.75 inches.

The stake 14 has a length L1. The length L1 is measured between a proximal, terminal end 66 of the stake 14 (or the head 48) and a distal, terminal end 68 of the stake 14 (or the tip 58). In various embodiments, the length L1 may be between 2 to 3 and 18 or 24 inches, between 6 and 14 inches, between 8 and 12 inches, between 9 and 11 inches, or about 10.4 inches.

A length L2 is measured between the ground cap 56 and the distal, terminal end 68 of the stake 14 (or the tip 58). In various embodiments, the length L2 may be between 2 and 22 inches, between 5 and 13 inches, between 7 and 11 inches, between 8 and 10 inches, or about 8.9 inches. The length L2 may correspond to the length of the shaft 60.

In various embodiments, a length L3 of the head 48 may be between 0.5 and 2.5 inches, between 1 and 2 inches, or about 1.3 inches. In various embodiments, a diameter or width D6 of the head 48 may be between 0.5 and 2 inches, between 0.5 and 1.5 inches, or about 1 inch.

In some embodiments, the stake 14 or the body 40 thereof is formed of aluminum. The stake 14 or the body 40 thereof may include a hard anodized finish or powder coated finish to avoid dulling of the blade and damage to the stake after repeated use. The hard anodized finish or powder coated finish may also help prevent oxidation and rust. In some embodiments, the stake 14 or the body 40 thereof is monolithic (e.g., the head 48, the tip 58, the shaft 60, the auger 62, and the ground cap 56 are all integrally formed).

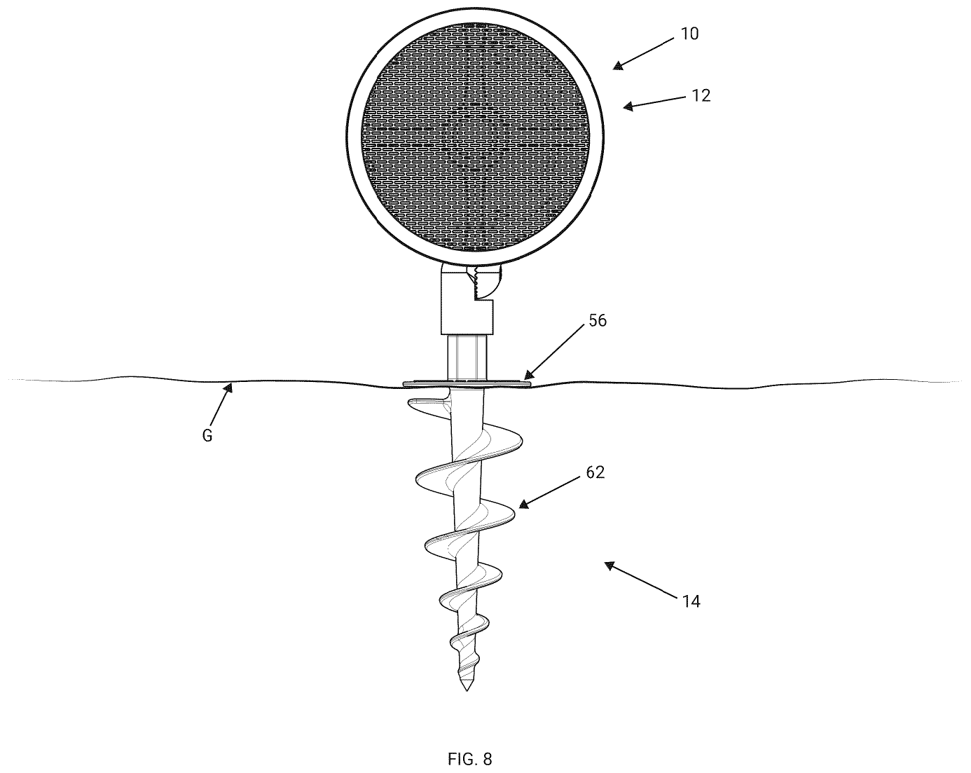

Example installation steps using the assembly 10 will now be described. First, an installer connects a power tool such as an impact driver to the head 48 of the stake 14. The installer positions the distal end 44 of the stake 14 at or adjacent the ground or other mounting structure. The installer operates the power tool such that the stake 14 rotates and the auger 62 is driven into the ground until the ground cap 56 is at or adjacent the ground. With reference to FIGS. 3, 6, and 8, with the stake 14 in the installed position in the ground G, the base 20 of the speaker 12 is received in the channel 52 of the head 48 of the stake 14. The conductors 22, 24 of the speaker 12 (FIG. 3) may be received through the aperture 54 of the head 48. As is understood by those of ordinary skill in the art, the conductors 22, 24 may be connected to burial or system wires to connect to additional speakers or other components such as an amplifier.

Embodiments of the present invention provide a (metal) hybrid auger-style/screw-style ground stake designed to not dig and excavate but instead to drill down and implant securely in the ground (this is unlike a typical auger that is used to simply bore holes). Installing landscape speakers is frustrating because of the antiquated method of driving a plastic stake in the ground with a hammer. Often, the stakes do not stay in position after installation, so the speakers mounted to them quickly begin to lean or sag, making the landscape and the installer look sloppy.

In contrast, embodiments of the present invention provide a stake that installs with an impact driver rather than a hammer. The stake is designed to grip the ground and resist sustained and impact forces in all directions. Installation is faster and easier. Further, the stake does not sag or lean, keeping the landscape and the installer looking sharp and professional and preventing expensive and time consuming return trips to the installation site.

Some key advantages of embodiments of the present invention include but are not limited to reducing installation time (e.g., save an average of 15 minutes per stake), eliminating wasted materials and trips for broken or bent stakes, eliminating return trips for sagging or leaning speakers, reducing effort by letting the impact driver and the stake do the hard work, improving resistance to damage from landscape equipment, enhancing installation flexibility with extension rods and/or flag caps, using strong, durable materials for long-lasting results, and including a weatherproof finish for durability in outdoor environments.

Embodiments of the present invention provide a stake with optimal size and type of drill interface for high-torque, low wrist-strain, and a wide variety of usable impact drivers (e.g., 12V and 18V). The stake may be installed using commonly available tools (e.g., impact driver and 1″ socket). As described herein, the stake employs optimal pitch, angle, and thickness of blades for cutting and embedding in soil, while not excavating.

In addition to case of installation, embodiments of the present invention provide a stake that is easy to uninstall. For example, the installer may switch the drive direction of the impact driver or power drill to reverse. There is less disturbance to the ground after uninstallation versus traditional stakes.

As described herein, embodiments of the present invention include features that enhance the strength, security, and permanence of the stake, including: optimal size blade for strength in all directions and resistance to tipping, even during impacts or high winds, optimal increase in circumference or diameter of blades, optimal size of blade surface area, optimal spacing of blades, optimal length of the stake, optimal circumference or diameter of the stake body, optimal material for strength, optimal strength and shape for penetrating hard packed soil, optimal strength and shape for glancing off stones, optimal shape for withstanding moisture-caused soil erosion (e.g., using air gap between ground cap and blade), capability of securing landscape speakers in various soils, terrains, and environments, one piece design for strength, and optimally sized interface between the stake and the driving tool to reduce torque demand and provide effective torque transfer during installation.

Further advantages associated with fitness for speaker mounting include that the stake installs to ground height every time, the stake includes optimal pass-through for wire management, the stake has optimal strength for weight support (e.g., 8″ speakers), and optimal strength for weight-induced torque resistance.

The stake according to embodiments also provides flexibility of use. For example, adapters could be used for different speaker interfaces. Adapters could also be used for different uses. “Quick connect” couplers may be used to couple appliances such as speakers to the stake. See, e.g., U.S. Patent Application Publication No. 2019/0356972, the disclosure of which is incorporated by reference herein in its entirety. Extension rods for height adjustment, thread-size conversion adapters, and other types of adapters or couplers may be used to meet different needs.

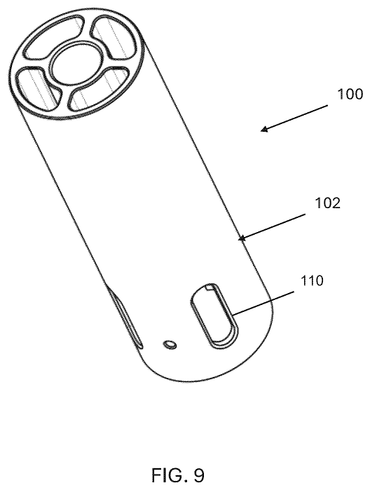

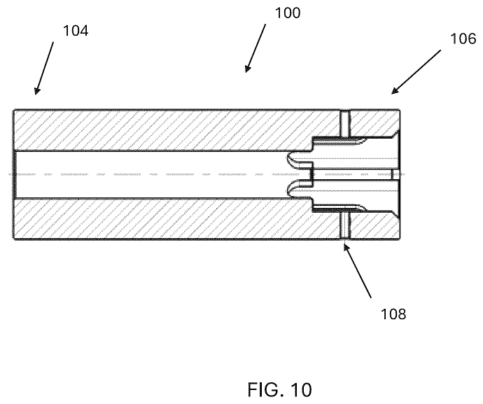

An example extension rod 100 is illustrated in FIGS. 9 and 10. The extension rod 100 is an elongated rod member attachable to the stake 14 to provide adjustable elevation for mounting speakers or other fixtures. The extension rod 100 includes a body 102 including a first, threaded end 104 configured to couple with a speaker or other fixture, and an opposite second end 106 configured to couple with the stake 14.

At least one aperture or hole 108 is defined in the body 102 of the extension rod 100. In some embodiments, first and second apertures 108 are provided, and the first and second apertures 108 may be diametrically opposed on the body 102 of the extension rod 100. At least one oblong cable pass-through aperture or hole 110 (or cable routing pathway(s)) may be defined in the body 102.

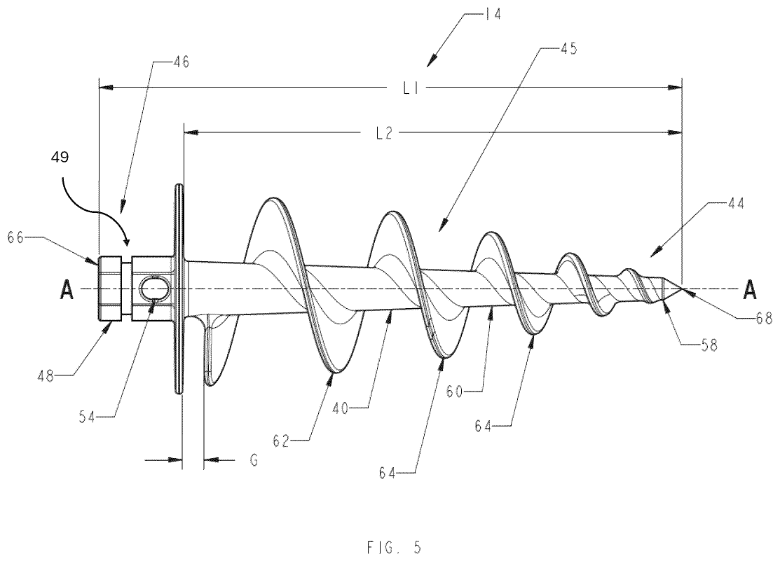

The aperture 108 is configured to receive a setscrew therethrough. The stake 14 includes an annular groove 49 within the head 48 (see FIG. 5). The groove 49 is configured to receive and align the setscrew(s), thereby securing the extension rod 100 and permitting angular adjustment of the mounted article. The extension rod 100 engages multiple surfaces of the stake 14, including the head 48 and the ground cap 56, to increase structural stability. The extension rod 100 enables attachment of a speaker without requiring rotation of the speaker relative to the stake 14, thereby reducing risk of cable damage and minimizing disturbance of the stake 14 after installation in the ground.

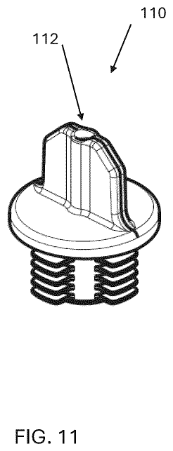

FIG. 11 is a perspective view of a flag cap 110 according to some embodiments. The flag cap 110 is a protective cap configured to insert into the threaded end of the stake 14 (e.g., at the head 48). The cap prevents damage to, and accumulation of debris within, the threaded portion of the stake 14 during installation. The cap 110 is dimensioned to remain in place while the stake 14 is driven using a deep impact socket. The cap 110 further includes a cylindrical receiver hole 112 sized to accept a landscape marking flag, thereby enabling the stake 14 to function as a temporary location marking device.

Although the present disclosure describes landscape speakers in detail, it is contemplated that stakes according to embodiments of the present invention could be used to stably mount a variety of appliances or outdoor fixtures including but not limited to landscape or outdoor lights, anchors for canopies or tents, shade sails, landscape shade umbrellas, tent stakes, feather banners, signs, tree or plant tie downs, tiki torches, light strings, sports nets (e.g., volleyball, badminton, etc.), playground equipment, boat tie downs at shoreline, pet leash tie downs, inflatable tie downs, trampoline tie downs, etc. The present inventors have discovered that the stake is useful as an anchor to restrain as an alternative or in addition to an anchor to mount. For example, the present inventors have tested the strength of the stake and have measured 260 KG of force required to uproot the stake.

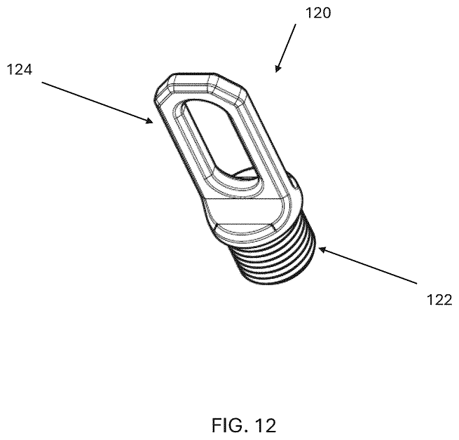

FIG. 12 is a perspective view of a static adapter 120 according to some embodiments. The static adapter 120 is an accessory including a threaded base 122 configured to couple with the threaded end of the stake 14 (e.g., at the head 48). The adapter 120 includes an integral upright loop structure 124 for receiving a tie, cable, or fastener. The adapter 120 provides a fixed attachment point with no relative movement between the loop 124 and the stake 14. The adapter 120 thereby permits the secure mounting of devices in a stationary orientation relative to the stake 14.

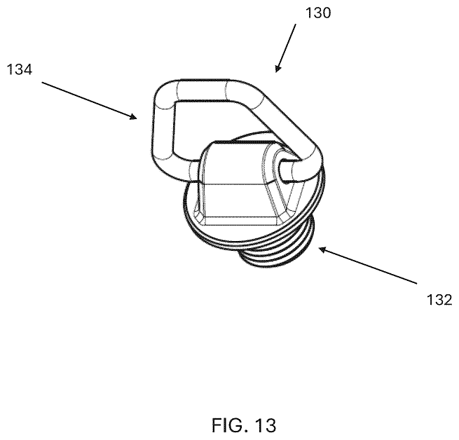

FIG. 13 is a single-axis pivot adapter 130 according to some embodiments. The pivot adapter 130 is an accessory including a threaded base 132 configured to couple with the threaded end of the stake 14 (e.g., at the head 48). The adapter 130 includes a loop structure 134 rotatably mounted to the base 132, the loop 134 being constrained for motion in a single plane about a pivot axis. This configuration allows attached devices to articulate within one degree of freedom while maintaining secure connection to the stake 14. The adapter 130 thereby accommodates adjustable orientation while preventing rotation about axes orthogonal to the pivot.

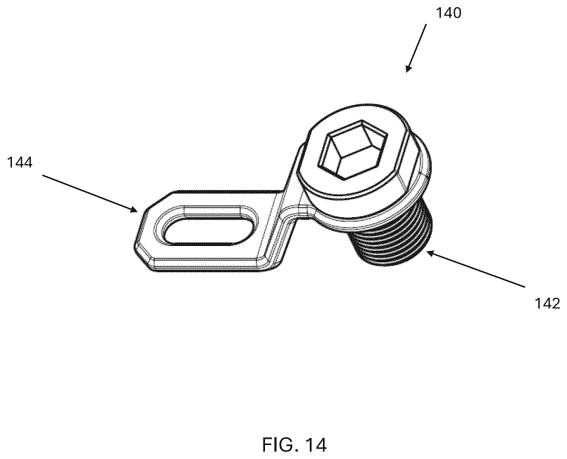

FIG. 14 is a perspective view of a swivel adapter 140 according to some embodiments. The swivel adapter 140 is an accessory including a threaded base 142 configured to couple with the threaded end of the stake 14 (e.g., at the head 48). The adapter 140 includes a loop structure 144 connected to the base 142 by a swivel joint permitting rotation about a vertical axis. The swivel joint thereby enables 360-degree rotational freedom of the loop relative to the stake 14, while maintaining axial retention. This configuration allows devices attached to the loop to rotate freely without transmitting torsional loads to the stake.

In some embodiments, an adapter kit includes the static adapter 120, the pivot adapter 130, and/or the swivel adapter 140. The adapter kit provides selectable attachment options that allow a user to choose between fixed, single-plane pivoting, and full swivel motion when mounting a device to the stake 14.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the teachings and advantages of this invention. Accordingly, all such modifications are intended to be included within the scope of this invention as defined in the claims. The invention is defined by the following claims, with equivalents of the claims to be included therein.

1. A stake for an outdoor fixture, the stake comprising:
a body including a proximal end portion and an opposite distal end portion, the body defining a longitudinal axis, the body comprising;
a head at the proximal end portion of the body;
a tip at the distal end portion of the body;
a shaft extending along the longitudinal axis between the head and the tip;
an auger on the shaft; and
a ground cap between the auger and the head,
wherein the head is shaped and configured to be coupled to a power tool to drive the auger in the ground until the ground cap is at or adjacent the ground such that the stake is in an installed position.

2. The stake of claim 1 wherein the head comprises a sidewall defining a channel, and wherein an inner surface of the sidewall comprises threads to threadingly engage an appliance when the stake is in the installed position.

3. The stake of claim 2 wherein the sidewall comprises at least one aperture configured to receive therethrough at least one conductor of the appliance.

4. The stake of claim 1 wherein the auger comprises a plurality of flights that are axially spaced apart from one another.

5. The stake of claim 4 wherein the plurality of flights decrease in diameter or width in a direction from the proximal end portion of the body to the distal end portion of the body.

6. The stake of claim 4 wherein the auger terminates before the ground cap such that a gap is defined between the ground cap and the flight closest to the ground cap.

7. The stake of claim 1 wherein the shaft decreases in diameter in a direction from the ground cap to the tip.

8. The stake of claim 1 wherein the body has a length between a proximal, terminal end of the body and a distal, terminal end of the body of between 8 and 12 inches.

9. The stake of claim 1 wherein the ground cap has a diameter or width greater than a diameter or width of the auger.

10. The stake of claim 1 wherein the body including the head, the tip, the shaft, the auger, and the ground cap is monolithic.

11. The stake of claim 1 wherein the body comprises aluminum.

12. The stake of claim 11 wherein the body comprises a hard anodized or powder coated finish.

13. A system for mounting an outdoor fixture, the system comprising:
an appliance; and
a stake comprising a body including a proximal end portion and an opposite distal end portion, the body defining a longitudinal axis, the body comprising;
a head at the proximal end portion of the body;
a tip at the distal end portion of the body;
a shaft extending along the longitudinal axis between the head and the tip;
an auger on the shaft; and
a ground cap between the auger and the head,
wherein the head is shaped and configured to be coupled to a power tool to drive the auger in the ground until the ground cap is at or adjacent the ground such that the stake is in an installed position, and
wherein the head is configured to receive and hold the appliance in the installed position.

14. The system of claim 13 wherein the appliance comprises a speaker.

15. A method for mounting an outdoor fixture, the method comprising:
providing speaker assembly comprising:
a speaker comprising a body and a base; and
a stake comprising a body including a proximal end portion and an opposite distal end portion, the body defining a longitudinal axis, the body comprising;
a head at the proximal end portion of the body;
a tip at the distal end portion of the body;
a shaft extending along the longitudinal axis between the head and the tip;
an auger on the shaft; and
a ground cap between the auger and the head;
driving the distal end portion and the auger of the stake into the ground until the ground cap is at or adjacent the ground; and
connecting the speaker to the stake by connecting the base of the speaker to the head of the stake.

16. The method of claim 15 wherein the driving step is carried out by connecting a power tool to the head of the stake and operating the power tool to rotate the stake.

17. The method of claim 15 wherein the head comprises a sidewall defining a channel configured to receive the base of the speaker, and wherein at least one aperture is defined in the sidewall, the method further comprising routing at least one conductor of the speaker through the at least one aperture before the connecting step.
